(19) United States
(12) Patent Application Publication
(10) Pub. No.: US 2002/0013747 A1
(43) Pub. Date: Jan. 31, 2002

(54) Method and apparatus for electronic filing of income tax returns by a taxpayer

(76) Inventors: Michael J. Valentine, Seabrook, TX (US); George R. Brazzel, League City, TX (US)

Correspondence Address: Michael J. Valentine, 1210 Bayport Blvd., Seabrook, TX, 77586, US

(21) Appl. No.: 09/790,953

(22) Filed: Feb. 22, 2001

Related U.S. Application Data
(60) Provisional application No. 60/184,414, filed on Feb. 23, 2000.

(51) Int. Cl. G06F 17/60

(52) U.S. Cl. 705/31; 705/35; 705/39

(57) ABSTRACT

The present invention is a unique business process system that looks like a free-standing ATM, internet access kiosk, video game, or check cashing kiosk. The present invention is a self-service tax preparation and electronic filing (e*file) device for Federal and State income tax returns. The Present invention allows consumers without access to a computer, the internet, a major credit card or a bank account to take advantage of electronic filing, direct deposit, refund anticipation loans (RAL), refund anticipation cashier's checks (RAC), and refund transfers (RT) without having to hire and pay a human tax preparer. The present invention will be placed in public locations, such as discount stores, grocery stores, postal service stores, malls, colleges and universities, and other retail or public locations. While using existing hardware and software that are in the public domain, the present invention's unique business process eliminates the need to pay live preparer fees, allows all taxpayers to access electronic filing and bank products, and reduces fee loads for lower income taxpayers while still allowing them access to now unavailable products such as e*file and RAL. The present invention is novel and unobvious in that all tax preparation has previously required either self preparation on paper, visiting a paid preparer, or owning a computer with access to the internet. It is useful in that it greatly expands access to e*filing and bank products (RAL, RAC, RT) and sharply reduces consumer costs for using these services.

### CROSS-REFERENCE TO RELATED APPLICATIONS

The present application claims the benefit of U.S. Provisional Application Ser. No. 60184,414, filed Feb. 23, 2000, entitled The Tax Machine, which is incorporated herein by reference.

### STATEMENT REGARDING FEDERALLY SPONSORED RESEARCH OR DEVELOPMENT

Not applicable.

### FIELD OF THE INVENTION

This invention relates generally to the field of income tax preparation. More particularly this invention relates to the electronic filing of income tax returns. Still more particularly the present invention relates to a method and apparatus that allows taxpayers to file tax returns electronically without utilizing a tax preparation company or any taxpayer owned electronic hardware. The uniqueness of the current invention is in the accessibility for a wide tax paying consumer base to e*filing and bank products, such as Refund Anticipation Loans (RAL), Refund Anticipation Checks (RAC), Refund Transfers (RT), and direct deposit refunds, without paying a live preparer during business hours.

### BACKGROUND OF THE INVENTION

Taxpayers currently have several choices if they want to prepare and electronically file their tax returns. Most traditionally, they can pay a professional preparer, such as a Certified Public Accountant, or a tax preparation company, such as H&R Block, to prepare and/or electronically file their returns. This method is usually costly. Taxpayers with a computer and internet access can prepare their tax returns with self-preparation software and then electronically file through a Transmitter or Intermediate Service Provider over the Internet. Several companies currently manufacture self-preparation tax software, but no one provides an avenue to use the software without a computer and IRS rules prohibit these companies from offering bank products over the Internet. The only other option is for the taxpayer to self-prepare his return and mail the return to the IRS. This method is considerably slower than the other two methods and is more prone to errors. Therefore it is desirable to dramatically reduce the cost to prepare and electronically prepare tax returns for taxpayers that do not have access to a computer or the Internet. It is also desirable to increase automated tax preparation availability and reduce fee loads for taxpayers not likely have a computer or access to the Internet, as is consistent with the Federal government's initiatives on bridging the digital divide.

E*filing allows taxpayers to electronically submit their returns to the IRS and/or state authority and receive their refunds in less than half the time that it takes to receive the refund through the mail. According to IRS figures, e*filing reduces the error rate on returns from the current 21% of all paper returns to less than 1% for electronically filed returns. The latest IRS statistics indicate that over 24.5 million returns were filed electronically in 1998 and that 34 million returns were electronically filed in 1999. The IRS's goal is to have 80% of all returns filed electronically by 2007. According to current IRS data, they will fall far short of this goal without major new initiatives being introduced. It is desirable to develop products that are consistent with new initiatives that will help the IRS meet its current goals.

Historically, lower income taxpayers are more likely to use e*filing and to use a paid preparer to e*file. The primary motivating factor for these taxpayers using paid preparers to file electronic, simple returns is to gain access to RALs, RACs, and RTs. About 25% of the 41 million taxpayers with adjusted gross incomes of $15,000 or less were electronically filed in 1997. Of the 24.6 million tax returns filed electronically in 1997, over 21.8 million were by taxpayers with adjusted gross income under $50,000, accounting for almost 89% of all e*filing in 1997. Over 73% of all e*filing in 1997 was done by a paid preparer. Lower income taxpayers are also more likely to use RALs and RACs and are much less likely to have a bank account. In such circumstances, the only access to RALs is through paid preparers, and the only access to cashier's check or other check payment is through paid preparers. In 1997, over 88 million taxpayers received refunds (approximately 72% of all individual returns). According to IRS statistics, over 50% of all returns were prepared by a paid tax preparer in 1997.

According to IRS data, the two major factors that limit the increase in e*filing by taxpayers is the cost of preparation and e*filing and the lack of a computer with access to the Internet. In fact, according to the National Telecommunications and Information Administration, “households with incomes of $75,000 and higher are more than twenty times more likely to have access to the Internet than those at the lowest income levels, and more than nine times as likely to have a computer at home.” In addition, those living in rural areas are lagging behind in Internet access regardless of income level. The government calls this the Digital Divide. It is advantageous to help close the gap between rural and urban areas and between upper and lower income levels, by allowing rural and/or low-income populations to e*file their tax returns and access bank products at a fraction of the cost that is currently available. It is also desirable to eliminate the need for taxpayers to have a personal computer to operate tax preparation software and the need to pay a preparer. Moreover, it is desirable to allow these taxpayers to access the full range of e*services, including bank products, e*filing, and direct deposits, at fees less than one-half of those charged by tax preparers nationwide, and to greatly expand access to these services through product availability in retail establishments and public venues with expanded hours of operation.

Several patents have been granted that seek to make e*filing more consumer friendly. U.S. Pat. No. 5,963,921, for example, discloses an electronic income tax refund payment system with means for creating a new deposit account for receipt of an electronically transferred refund from the IRS. The present invention is distinct from this patent in that it provides access and self-preparation in publicly accessible locations.

U.S. Pat. No. 5,724,523 discloses an electronic income tax refund system utilizing the tax refund to underwrite issuance of a secured credit card. The present invention is distinct from this patent in that it provides access and self-preparation to these services in publicly accessible locations, and provides for self-creation and coding of the “smart card.”

As noted, these patents, however, do not provide any new avenues for taxpayers to access these services and bank products. The present invention provides a unique way of helping low to moderate income individuals without computers and/or bank products self-prepare their own tax returns and access bank products that are currently only available with paid preparers. Additionally, the present invention reduces fees for these individuals to a fraction of current charges, and will support the Federal government's goal of receiving most simple tax returns in electronic format. Furthermore, the present invention will further enhance accuracy and security, and reduce the labor costs to both the Federal government and state tax agencies through improved data and submissions.

### SUMMARY OF THE INVENTION

One novel feature of the present invention is that it provides low-income and/or rural populations an avenue to self-prepare and electronically file their own tax returns and access bank products, such as refund anticipation loans (RAL), cashier's checks (RAC), and direct deposits (RT). Currently self-preparation software is only available to taxpayers that have computers. The present invention will bring this service to the huge number of taxpayers without computers that can currently only e*file through a paid preparer.

Another novel feature of the present invention is that taxpayers can self-prepare tax returns, take advantage of the most up-to-date tax preparation software and sharply reduce the high fees associated with using a paid tax preparer.

Yet another novel feature of the present invention is that taxpayers can receive refund anticipation loans that are by IRS regulations currently not available to online filers (taxpayers that e*file over the Internet.) Because the present invention complies with all regulations relating to Debt Indicator data collection and reporting, it is one of a handful of methods that is exempted from this restriction. As such, the present invention can offer on-line, self-prepared tax returns and bank products (RAL, RAC, and RT).

### BRIEF DESCRIPTION OF THE DRAWINGS

For a detailed understanding of the present invention, reference will be made to the attached figures, wherein:

FIG. 1 demonstrates the process and decision tree flow of the invention; and

FIG. 2 demonstrates the physical kiosk.

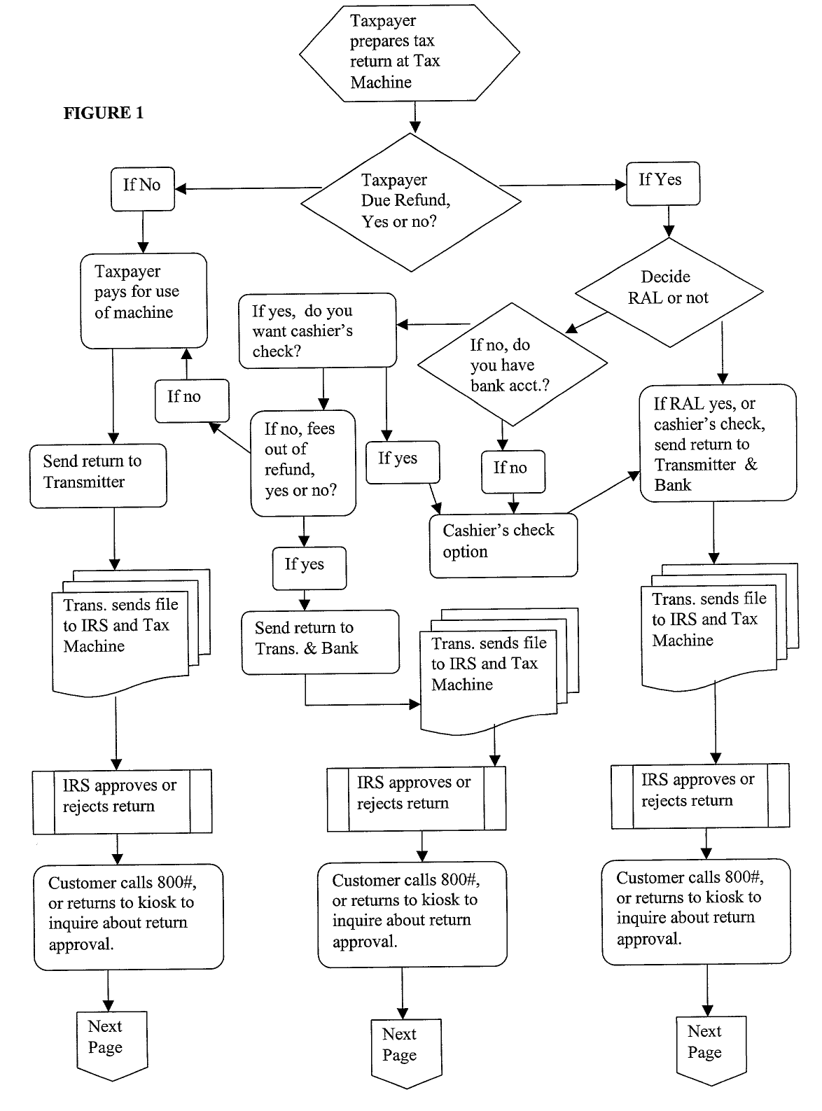

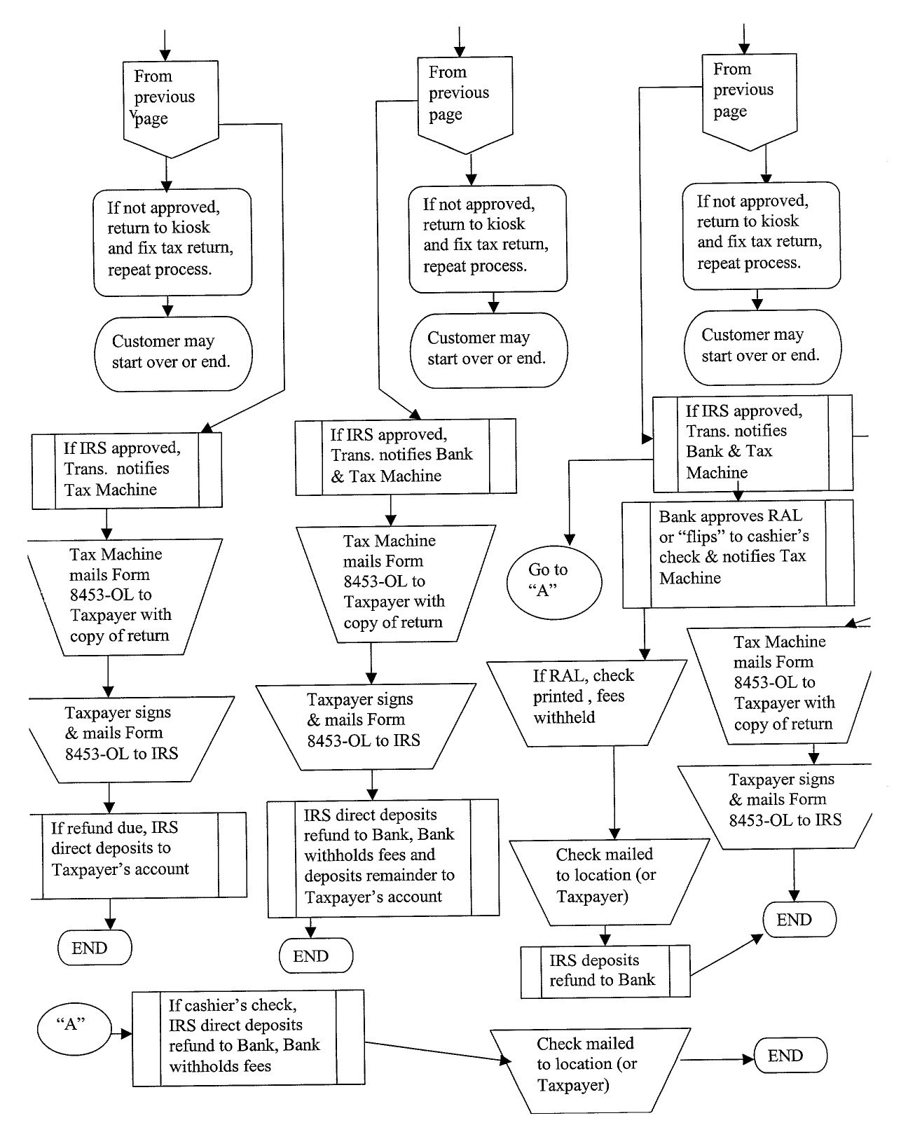

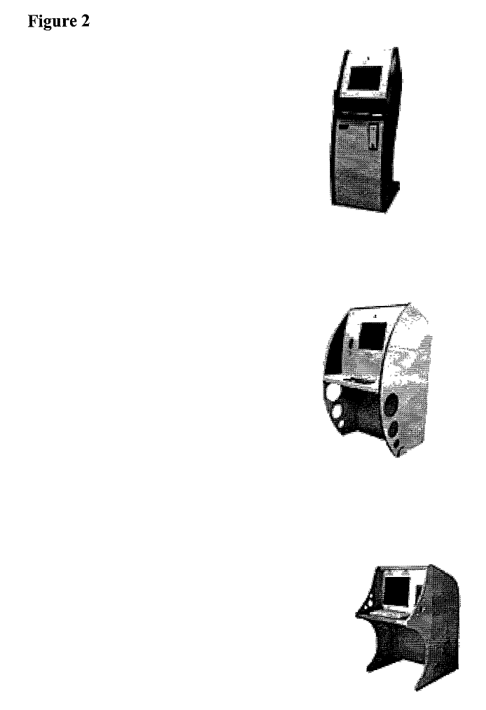

### DETAILED DESCRIPTION OF THE PREFERRED EMBODIMENTS

The Present invention is a business process that is unique, never before made available in the United States or other country. The preferred embodiment of the current invention is a kiosk located in an area that is accessible to the public. The kiosk generally comprises a housing, likely made of laminate, approximately the same dimensions of a free-standing ATM or check cashing machine, a video display monitor, an input device, such as a keyboard, a data connection to the Internet or a network, and a computer specially programmed with tax preparation software. Preferably the kiosk would be equipped with a magnetic card reader and encoder so that customers could receive refunds onto a debit card, or “smart card”, and pay for services and owed taxes. Additionally the input device could be a touch screen monitor. The kiosk could also contain provisions to communicate with a technical support technician, such as a digital camera and speakers, or a telephone handset. The kiosk is remotely controlled by a Network Operations Center, that can monitor the activity of the kiosk, perform software upgrades remotely, change kiosk setting, control access to the Internet and different websites, monitor usage, monitor cash and credit card intake, and control and monitor the tax preparation software if necessary.

Using tax preparation software, the kiosk invites tax payers to use it to self-prepare their simple tax returns much as they could if they had a home computer, purchased the software and had internet access. By virtue of its thorough development, the kiosk will also enable these taxpayers to access bank products, such as direct deposit into their bank account, Refund Anticipation Loans which provide them their tax refunds on the next business day, or cashier's checks for taxpayers who do not qualify for the refund loan and do not have a bank account are available to give the taxpayer their refunds more quickly than the normal refund process allows. Currently, the only bank product available to even taxpayers with a home computer and internet access is the direct deposit. The kiosk offers bank products that even wealthier taxpayers cannot access without using a live, paid preparer.

The kiosks are placed in grocery stores, malls, universities, or colleges, or public spaces that allow access during a broader span of hours than are the live tax preparers. The kiosks are intent on reaching a taxpayer base who presently use live tax preparers in huge numbers—these taxpayers, unexpectedly, are those with the simplest of returns and the lowest adjusted gross incomes—taxpayers for whom rapid recovery of their tax refund is vital. Only paid tax preparers who have made arrangements with an authorized bank can offer refund anticipations loans—next day tax refunds—or other bank products that are crucial to the financial health of these taxpayers.

For such a simple return as a 1040EZ with a refund anticipation loan, a low income taxpayer can expect to be charged as much as $250.00 from his or her refund. This constitutes a huge penalty for the taxpayer's urgent need to have the refund in his or her hands as quickly as possible. The kiosk will allow these taxpayers to access bank products, self-prepare their own tax returns and pay only a fraction of the fees charged by live preparers.

The unique business process is conversion of tax self-preparation software into a format useable by an interview in different languages such as Spanish or English, together with a thorough preparation process that makes bank products available to self-filers without a live preparer. The kiosk utilizes unique security measures, including photo imaging of the taxpayer, to nearly eliminate fraud. These security measures, coupled with the full compliance with the IRS Debt Indicator process, allow only the Present invention to provide self-preparers access to these vital bank products without having to own a home computer and have internet access.

By providing broad, easy access, making tax self-preparation available to taxpayers who cannot afford computers and internet access, reducing the fee structure for low income taxpayers and providing bank products to taxpayers who cannot afford home computers and/or do not have bank accounts, the Present invention kiosk truly represents a breakthrough in delivering technology and needed financial products to a broad, underserved taxpayer consumer.

The current invention allows customers an easy way to fill out their tax returns by providing a simple, easy to follow software program, which will automatically electronically file their returns. The kiosks are preferably placed in public locations where our customers congregate, such as retail stores, grocery stores, malls, postal service stores, colleges or universities, discount stores, malls, or other public locations. The software will provide simple instructions and require a minimum of typing. The kiosks will prepare only simple tax returns (itemized deductions and earned income tax credit will be allowed) and will specifically exclude schedule C in the first year. This will minimize confusion and limit the total amount of time required to complete the return. Future versions will prepare more complex tax returns. The kiosk will also allow for taking a digital picture of the user in order to combat tax fraud and earned income tax credit fraud.

The kiosks will be placed near the customer service section of a retailer or in a public venue. The taxpayer will complete the tax return by answering very simple questions on the computer screen. After completing the return the customer has the option of to pay for the use of the machine at the customer service desk of the retailer. (A future alternative is to allow customers to pay for the usage through credit cards, debit cards, pre-paid phone cards or in cash.) If the taxpayer chooses the pay in advance option, the refund can be by direct deposit or paper check. The tax return will then be electronically transmitted to the Transmitter who will then transmit the return to the IRS. Once the IRS accepts the tax return, the tax return will be printed at a central print center that will then mail the printed return and the Form 8453-OL to the taxpayer. (A future alternative is to have each kiosk contain a printer that prints a copy of the tax return and the Form 8453-OL for individual customers on the spot.) The customer will then be instructed to sign Form 8453-OL (along with his/her spouse if filing jointly) and mail the form to the IRS. Printing and delivery of the forms is the same regardless of how the taxpayer pays for the usage of the kiosk. The customer will be given a toll free number to call within 24 to 48 hours of completing his return to determine if his tax return has been accepted or can return to the kiosk to check the status of the tax return. If the tax return is not accepted the taxpayer he will be instructed to correct any missing or incorrect information.

There are but two primary, initial decisions after the taxpayer self-prepares his return—whether they are due a tax refund or not. Following the refund/no refund decision, the taxpayer either chooses the method of payment for the transaction and files the return electronically (no refund) or elects payment, refund methodology and files the return electronically (refund.) While completing the tax return, the customer will be given the option of applying for a refund anticipation loan. If the taxpayer accepts this option, when the tax return is submitted to the IRS, the loan application will be submitted to the designated bank. Once the IRS accepts the return, the bank will release the funds and a check will be printed (usually within 24 to 48 hours of e*filing) and overnighted to the location. The location will check IDs and distribute the checks to customers. The location will then have the option of cashing the check for a fee. If the loan is not approved, the taxpayer will receive a cashier's check once the refund has been deposited in the bank's account. If the IRS does not accept the return, the customer will be given the opportunity to correct any errors and begin the process again. Alternatively, the check can be sent directly to the taxpayer, or picked up by the taxpayer at a bank or other secure location. A RAL can also be directly deposited to the taxpayer's bank account is he/she has one. Fees will come out of the refund, there is no up front cost.

If the taxpayer elects not to have an RAL, he/she will be given the option of having the refund deposited directly into a bank account. If the taxpayer does not have a bank account, the taxpayer will be given the option of receiving the refund within about 10 to 14 days via a cashier's check. There will be an additional fee for this service, which can be deducted directly from the tax refund. This option will also allow the taxpayer to pay for the use of the kiosk through the tax refund, thus eliminating any up front cost. Alternatively, the refund could be direct deposited into the retailer's account and the taxpayer can pick up the refund in cash at the retailer's service desk. Security and delivery of the check is similar to the RAL process above.

The taxpayer will also be given the option of having the refund directly deposited into the taxpayer's his own checking or savings account, less the fees for use of the machine and the fees for transferring money into his account. This option will allow the taxpayer to prepare and e*file his return with no up-front costs. The fees are taken directly out of his refund.

All tax returns will be sent initially to the Transmitter and then to the print center. If bank products are requested by the taxpayer, the Transmitter will send the return to the designated bank or financial service institution that will provide the bank products. The print center will print copies of tax returns and any other necessary forms and send this to the taxpayers. Taxpayers will be able to check on the status of their e*filed returns and bank products requests by calling the call center or checking the status at the kiosk.

The kiosks will process these returns initially in English and Spanish; Mandarin Chinese, Vietnamese, and other language presentations are included in this application and are contemplated.

The current invention is a unique business process, novel and unobvious. It has not heretofore been brought to market inasmuch as it will greatly diminish the revenue streams of established, live tax preparation firms, accountants and CPAs. The tax preparation business is considered to be mature, and any interruption of the normal flow of the greatest element of the live tax preparation business is anathema to their model.

The current invention provides identical tax preparation quality and accuracy to any taxpayer. It is secure, private, much less expensive than live preparation and makes available the immediate refund bank products that drive simple form taxpayers to the live preparers each year.

The current invention is consistent with the Federal Government's policies and initiatives to bridge the digital divide, and once broadly distributed will greatly reduce the paperwork burden on the Federal Government and state governments through enhancing and increasing digital, accurate, timely tax filings.

By reducing the fee load on lower-income taxpayers, the current invention provides additional income to them for consumer spending. By reducing the fee load, the current invention offers incentives all taxpayers to self-prepare, file early and file timely. By providing ready access, in some locations through 24 hours of the day, the Present invention brings self-preparation and bank products to taxpayers who must otherwise make special arrangements to visit a self-preparer.

The kiosk itself is not limited to any specific size or exterior design. The only limitations are self-imposed by the location as to size and shape. The contents and characteristics of the kiosk are essentially a personal computer, speakers, digital video camera, a monitor or touch screen monitor, a keyboard, a telephone handset, a credit card or magnetic stripe reader, and a bill (currency) acceptor. The computer will connect to the internet with a variety of internal devices, such as a dial up modem, a network card, or a direct connection. The kiosk has preloaded kiosk management software available from a variety of commercial vendors. The kiosk is remotely controlled by a Network Operations Center, that can monitor the activity of the kiosk, perform software upgrades remotely, change kiosk setting, control access to the internet and different websites, monitor usage, monitor cash and credit card intake, and control and monitor the tax preparation software if necessary. The tax preparation software is ASP based and is accessed through the kiosk and is located on a secure server.

The following is an explanation of a typical transaction using the Tax Machine tax preparation kiosk.

The taxpayer makes the decision to use the kiosk by viewing the welcome screen and obtaining information about the process on the “front end” of the software. When the taxpayer is ready to prepare the tax return, they get an account number and provide basic information about themselves.

Next the taxpayer logs on into his account. Returning customers log on using their account information also. Taxpayers then proceed to the basic information screen or use the interview to answer basic tax questions, such as name, address, social security number, filing status and etc. Bank information is also collected here for direct deposit refunds.

W-2 pages are designed to look like a common W-2 and are easy to fill out. Other forms are user friendly or automatically generated by the tax software. Examples of screens and forms that can be used in the present invention are included in Appendix A attached hereto, which is intended to be illustrative only and not limiting on the claims that follow.

The tax calculation software can either be designed particularly for use in the present invention or can be licensed and/or customized from any number of tax software developers.

The present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

What is claimed is:

1. A method for taxpayer self-preparation of income tax returns comprising the steps of:
entering, by the taxpayer, of taxpayer data into a publicly accessible electronic data processing machine;
converting taxpayer data into a electronic tax return data file;
transmitting said taxpayer data and said data file to a remote processing center by electronic means; and
transmitting said data file from said remote processing center to at least one tax collecting entity by electronic means.

2. The method of claim 1 further comprising the steps of:
providing confirmation to taxpayer of acceptance of said data file by said tax collecting entity; and
providing to taxpayer any forms required by said tax collecting entity.

3. The method of claim 1 further comprising the steps of:
providing taxpayer data to a financial service institution;
providing a refund anticipation loan or a cashier's check for the anticipated value of any tax refund minus any fees charged.

4. The method of claim 1 further comprising the steps of:
entering taxpayer bank account information into said data processing machine;
transmitting said bank account information to said remote service provider;
transmitting said bank account information to said tax collecting entity; and
depositing any tax refund into taxpayer's bank account directly from said tax collecting entity.

5. The method of claim 1 further comprising the steps of:
transferring any tax refund amount into the account of a third party;
paying any tax refund amount, less any fees charged by said third party, to said taxpayer by way of cash or check issued by said third party.

6. The method of claim 1 further comprising the step of issuing any tax refund to the taxpayer by way of a smart card or debit card.

7. The method of claim 1 further comprising the step of collecting any unpaid taxes or fees from the taxpayer at said publicly accessible electronic data processing machine.

8. A kiosk for taxpayer filing of income tax returns comprising:
a housing containing all components;
an electronic data processing unit containing a program capable of creating electronic tax returns from input data;
at least one input device;
a video display monitor; and
a data transmission means.

9. The kiosk of claim 8 further comprising a magnetic card reader and encoder.

10. The kiosk of claim 8 further comprising a digital video camera and audio speakers.

11. The kiosk of claim 8 further comprising a telephone handset.

12. A kiosk for taxpayer filing of income tax returns comprising:
a housing containing all components;
an electronic data processing unit containing a program capable of creating electronic tax returns from input data;
a touch screen monitor for input and display of data; and
a data transmission means.

9. The kiosk of claim 12 further comprising a magnetic card reader and encoder.

10. The kiosk of claim 12 further comprising a digital video camera and audio speakers.

11. The kiosk of claim 12 further comprising a telephone handset.
